(19) United States
(12) Patent Application Publication
(10) Pub. No.: US 2007/0011432 A1
(43) Pub. Date: Jan. 11, 2007

(54) Address generation unit with operand recycling

(75) Inventors: Michael E. Tuuk, Round Rock, TX (US); David E. Kroesche, Round Rock, TX (US); Wing-Shek Wong, Austin, TX (US)

Correspondence Address: MEYERTONS, HOOD, KIVLIN, KOWERT & GOETZEL (AMD), P.O. BOX 398, AUSTIN, TX, 78767-0398, US

(73) Assignee: Advanced Micro Devices, Inc.

(21) Appl. No.: 11/175,725

(22) Filed: Jul. 6, 2005

(51) Int. Cl. G06F 12/00

(52) U.S. Cl. 711/217; 711/219

(57) ABSTRACT

An address generation unit (AGU) including a single adder and a recycling path. The recycling AGU may receive a plurality of operands at a first and at a second selection device to perform a first address generation operation. The adder may sum a portion of the operands to generate an output sum. Then, the output sum may be recycled back to the first selection device via the recycle path. The sum that is output from the adder may be recycled back to the first selection device one or more times via the recycle path depending on whether the first address generation operation requires one or more additional operands to be added to generate a corresponding address. Since the recycling AGU includes only a single adder, it may reduce the hardware necessary to perform the multiple computations that are typically required in an address generation operation without adversely affecting performance.

### BACKGROUND OF THE INVENTION

1. Field of the Invention

This invention relates to microprocessors and, more particularly, to address generation units used in microprocessors to perform address calculations.

2. Description of the Related Art

Many modern processors include address generation mechanisms (e.g., address generation unit) to generate addresses needed to perform read or write operations in memory. In a read operation, an address may be generated that specifies the location in memory where the data or instruction to be fetched is located. In a write operation, an address may be generated that specifies an area in memory that is available for storing data.

Address generation in an x86 processor typically requires up to four operands to support the generic address case. A fifth operand may be required to compute the address of the sequential line in the case where an access to the internal cache requires data from two cache lines. For example, the operands may include at least one or more of the following: an index register operand, a base register operand, a displacement operand, and a segment base operand. The actual number of operands used to generate an address varies from operation to operation. Some address calculations may require a single operand while others may use the maximum number. In some operations, the sum of an index register operand, a base register operand, a displacement operand, and a segment base operand may form a virtual address. The virtual address may subsequently be translated through a paging mechanism to derive the physical address.

An address generation unit (AGU) may include a plurality of adders to perform the address generation functions. In a high frequency microprocessor, it may be desirable that an adder have as few operands as possible, i.e., preferably only two operands. This restriction necessitates the use of multiple adders in AGUs to add more than two operands. A conventional AGU may include multiple adders, each adder summing two operands to generate the address. For example, a first level adder may add two operands, the second level adder may add the output from the first level adder to a third operand, and so on until the address is generated. Then, selection circuitry may multiplex the final result to the cache. Since a typical AGU requires multiple adders, a considerable amount of die area is used for the AGU. In some implementations, to save die area, a wide adder having four or five inputs may be used for an AGU to be able to add the maximum number of operands. However, wide adders are typically very slow and therefore are not feasible for AGU designs. Address generation operations using a wide adder may significantly increase the cycle time.

### SUMMARY OF THE INVENTION

Various embodiments of an address generation unit (AGU) with operand recycling are disclosed. The recycling AGU is configured to perform address generation functions using a single adder. The recycling AGU may include an adder, a first selection device and a second selection device. The first and second selection devices (e.g., multiplexers) may be connected to the first and second input terminals of the adder. The recycling AGU may also include a recycle path to connect the output terminal of the adder to one of the selection devices.

The recycling AGU may receive a first operand at the first selection device and a second operand, a third operand, a fourth operand, and a fifth operand at the second selection device to perform a first address generation operation. The adder may sum a portion of the plurality of the operands to generate an output sum. Then, the output sum of the adder may be recycled back to the first selection device via the recycle path to perform the first address generation operation using a single adder. The sum that is output from the adder may be recycled back to the first selection device one or more times via the recycle path depending on whether the first address generation operation requires one or more additional operands to be added to generate a corresponding address.

Since the recycling AGU includes only a single adder, it reduces the hardware necessary to perform the multiple computations that are typically required in an address generation operation without adversely affecting performance. An extra cycle may be used to recycle the result of a computation back into the adder so additional operands may be added, but performance is typically maintained (and sometimes improved) by allowing other address calculations to use the adder during the extra cycle when the results are recycled. By allowing interleaving of address calculations overall throughput may not be affected. Additionally, the die area that is required for a typical AGU is greatly reduced when using the recycling AGU since it eliminates the extra adder stages.

In an initial computation of the first address generation operation, the adder may sum the first operand and one of the second, third, fourth, and fifth operands to generate a first output sum. The first output sum may then be recycled back to the first selection device via the recycle path. If the first address generation operation requires additional operands to be added, then at least one or more of a first, second, and third recycle computations may be performed. In a first recycle computation of the first address generation operation, the adder may sum the first output sum and one of the second, third, fourth, and fifth operands that was not selected in the initial computation to generate a second output sum, which may then be recycled back to the first selection device via the recycle path. In a second recycle computation of the first operation, the adder may sum the second output sum and one of the second, third, fourth, and fifth operands that was not selected in the initial or first recycle computations to generate a third output sum, which may then be recycled back to the first selection device via the recycle path. In a third recycle computation of the first operation, the adder may sum the third output sum and one of the second, third, fourth, and fifth operands that was not selected in the initial, first recycle, or second recycle computations to generate a fourth output sum, which may be recycled back to the first selection device via the recycle path.

The number of operands to be summed in a particular address generation calculation varies from operation to operation. For example, the initial, first recycle, and second recycle computations may be performed if at least four operands are to be summed in a particular address generation calculation. Also, the recycling AGU may interleave a second address generation operation with the first address generation operation to use the adder to perform computations during a cycle when an output sum is recycled for the first address generation operation.

### BRIEF DESCRIPTION OF THE DRAWINGS

FIG. 1 is a block diagram of one embodiment of an exemplary microprocessor including a recycling AGU;

FIG. 2 is a block diagram of one embodiment of a recycling AGU including a single adder;

FIG. 3 is a flow diagram illustrating a method for performing address generation calculations using the recycling AGU, according to one embodiment; and

FIG. 4 a block diagram of one embodiment of a computer system 400 including the microprocessor of FIG. 1.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims. Note, the headings are for organizational purposes only and are not meant to be used to limit or interpret the description or claims. Furthermore, note that the word “may” is used throughout this application in a permissive sense (i.e., having the potential to, being able to), not a mandatory sense (i.e., must). The term “include”, and derivations thereof, mean “including, but not limited to”. The term “coupled” means “directly or indirectly connected”.

### DETAILED DESCRIPTION

Microprocessor

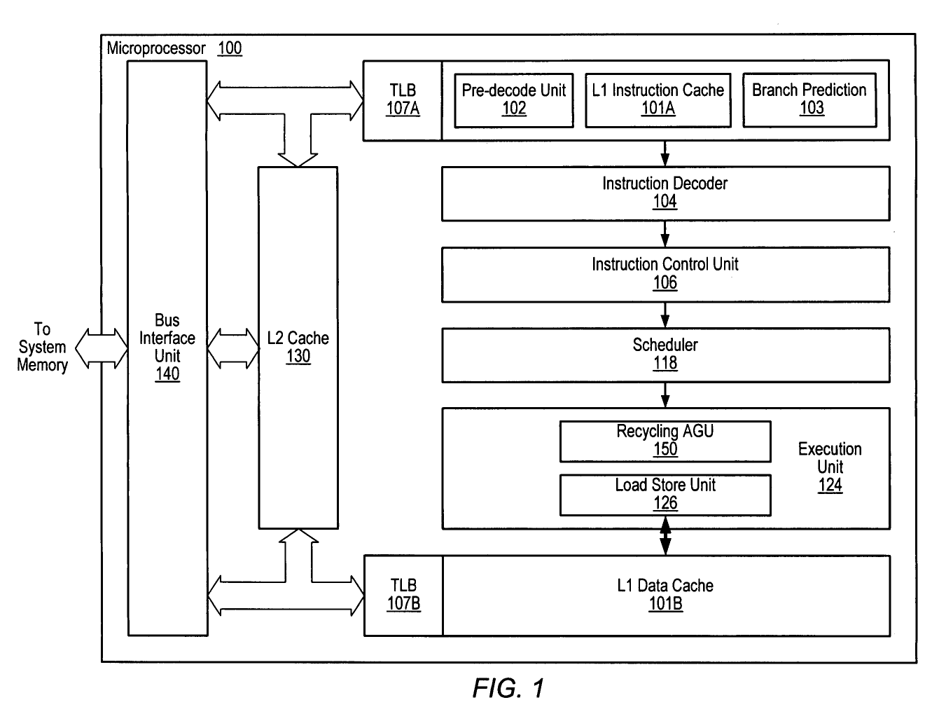

Turning now to FIG. 1, a block diagram of one embodiment of an exemplary microprocessor 100 is shown. Microprocessor 100 is configured to execute instructions stored in a system memory (not shown in FIG. 1). Many of these instructions may operate on data also stored in the system memory. It is noted that the system memory may be physically distributed throughout a computer system and may be accessed by one or more microprocessors such as microprocessor 100, for example. In one embodiment, microprocessor 100 is an example of a microprocessor which implements the x86 architecture such as an Athlon™ processor, for example. However, other embodiments are contemplated which include other types of microprocessors.

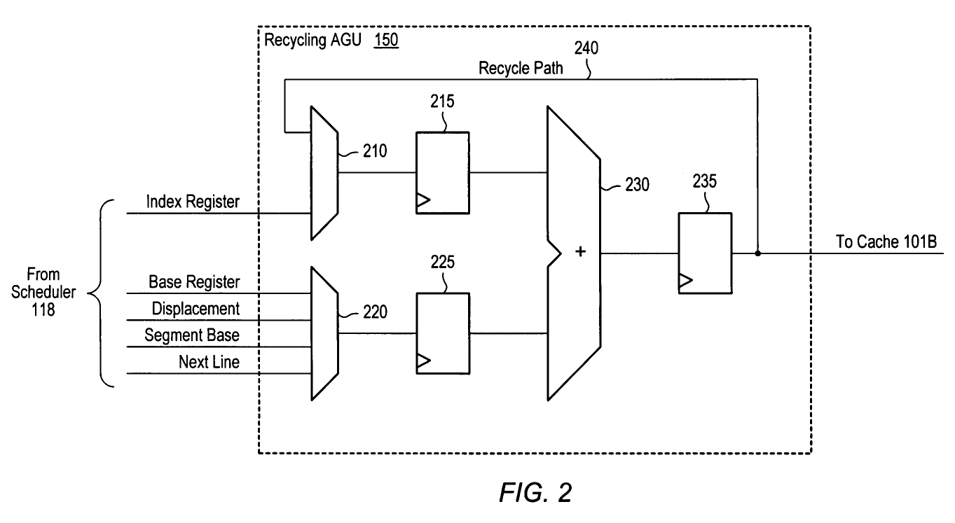

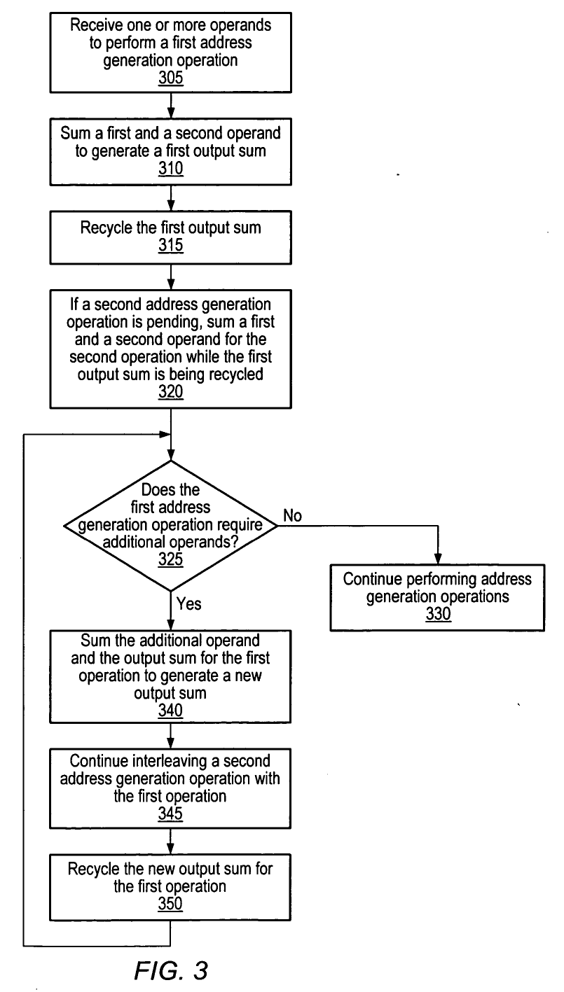

In the illustrated embodiment, microprocessor 100 includes cache system including a first level one (L1) cache and a second L1 cache: an instruction cache 101A and a data cache 101B. Depending upon the implementation, the L1 cache may be a unified cache or a bifurcated cache. In either case, for simplicity, instruction cache 101A and data cache 101B may be collectively referred to as L1 cache 101 where appropriate. The microprocessor 100 also includes a pre-decode unit 102 and branch prediction logic 103 which may be closely coupled with instruction cache 101A. The microprocessor 100 also includes an instruction decoder 104, which is coupled to instruction cache 101A. An instruction control unit 106 may be coupled to receive instructions from instruction decoder 104 and to dispatch operations to a scheduler 118. The scheduler 118 is coupled to receive dispatched operations from instruction control unit 106 and to issue operations to execution unit 124. The execution unit 124 includes a load/store unit 126 which may be configured to perform accesses to data cache 101B. Results generated by execution unit 124 may be used as operand values for subsequently issued instructions and/or stored to a register file (not shown). The execution unit 124 also includes a recycling address generation unit (AGU) 150 to perform address generation operations, as will be further described below with reference to FIG. 2 and FIG. 3. Furthermore, the microprocessor 100 includes an on-chip L2 cache 130 which is coupled between instruction cache 101A, data cache 101B and the system memory. It is noted that alternative embodiments are contemplated in which L2 cache memory 130 resides off-chip.

The instruction cache 101A may store instructions before execution. Functions which may be associated with instruction cache 101A may be instruction fetches (reads), instruction pre-fetching, instruction pre-decoding, and branch prediction. Instruction code may be provided to instruction cache 101A by pre-fetching code from the system memory through buffer interface unit 140 or from L2 cache 130. Instruction cache 101A may be implemented in various configurations (e.g., set-associative, fully-associative, or direct-mapped). In one embodiment, instruction cache 101A may be configured to store a plurality of cache lines where the number of bytes within a given cache line of instruction cache 101A is implementation specific. Further, in one embodiment instruction cache 10A may be implemented in static random access memory (SRAM), although other embodiments are contemplated which may include other types of memory. It is noted that in one embodiment, instruction cache 101A may include control circuitry (not shown) for controlling cache line fills, replacements, and coherency, for example.

The instruction decoder 104 may be configured to decode instructions into operations which may be either directly decoded or indirectly decoded using operations stored within an on-chip read-only memory (ROM) commonly referred to as a microcode ROM or MROM (not shown). Instruction decoder 104 may decode certain instructions into operations executable within execution unit 124. Simple instructions may correspond to a single operation. In some embodiments, more complex instructions may correspond to multiple operations.

The instruction control unit 106 may control dispatching of operations to execution unit 124. In one embodiment, instruction control unit 106 may include a reorder buffer (not shown) for holding operations received from instruction decoder 104. Further, instruction control unit 106 may be configured to control the retirement of operations.

The operations and immediate data provided at the outputs of instruction control unit 106 may be routed to scheduler 118. Scheduler 118 may include one or more scheduler units (e.g. an integer scheduler unit and a floating point scheduler unit). It is noted that as used herein, a scheduler is a device that detects when operations are ready for execution and issues ready operations to one or more execution units. For example, a reservation station may be a scheduler. Each scheduler 118 may be capable of holding operation information (e.g., bit encoded execution bits as well as operand values, operand tags, and/or immediate data) for several pending operations awaiting issue to an execution unit 124. In some embodiments, each scheduler 118 may not provide operand value storage. Instead, each scheduler 118 may monitor issued operations and results available in a register file in order to determine when operand values will be available to be read by execution unit 124. In some embodiments, each scheduler 118 may be associated with a dedicated one of execution unit 124. In other embodiments, a single scheduler 118 may issue operations to more than one of execution unit 124.

In one embodiment, the execution unit 124 may include an execution unit such as and integer execution unit, for example. However in other embodiments, microprocessor 100 may be a superscalar processor, in which case execution unit 124 may include multiple execution units (e.g., a plurality of integer execution units (not shown)) configured to perform integer arithmetic operations of addition and subtraction, as well as shifts, rotates, logical operations, and branch operations. In addition, one or more floating-point units (not shown) may also be included to accommodate floating-point operations.

The recycling AGU 150 of the execution unit 124 may be configured to perform address generation for load and store memory operations to be performed by load/store unit 126. The recycling AGU 150 may perform address generation operations using a single adder by recycling sums of operands from the output of the adder to the input stage of the recycling AGU 150, as will be further described below with reference to FIG. 2 and FIG. 3. Also, the recycling AGU 150 may interleave an additional address generation operation with an initial address generation operation to use the adder to perform computations during a cycle when an output sum from the adder is recycled for the initial address generation operation, as will be further described below with reference to FIG. 2 and FIG. 3.

The load/store unit 126 may be configured to provide an interface between execution unit 124 and data cache 101B. In one embodiment, load/store unit 126 may be configured with a load/store buffer (not shown) with several storage locations for data and address information for pending loads or stores. The load/store unit 126 may also perform dependency checking on older load instructions against younger store instructions to ensure that data coherency is maintained.

The data cache 101B is a cache memory provided to store data being transferred between load/store unit 126 and the system memory. Similar to instruction cache 101A described above, data cache 101B may be implemented in a variety of specific memory configurations, including a set associative configuration. In one embodiment, data cache 101B and instruction cache 101A are implemented as separate cache units. Although as described above, alternative embodiments are contemplated in which data cache 101B and instruction cache 101A may be implemented as a unified cache. In one embodiment, data cache 101B may store a plurality of cache lines where the number of bytes within a given cache line of data cache 101B is implementation specific. In one embodiment data cache 101B may also be implemented in static random access memory (SRAM), although other embodiments are contemplated which may include other types of memory. It is noted that in one embodiment, data cache 101B may include control circuitry (not shown) for controlling cache line fills, replacements, and coherency, for example.

The L2 cache 130 is also a cache memory and it may be configured to store instructions and/or data. In the illustrated embodiment, L2 cache 130 is an on-chip cache and may be configured as either fully associative or set associative or a combination of both. In one embodiment, L2 cache 130 may store a plurality of cache lines where the number of bytes within a given cache line of L2 cache 130 is implementation specific. It is noted that L2 cache 130 may include control circuitry (not shown in FIG. 1) for scheduling requests, controlling cache line fills and replacements, and coherency, for example.

The bus interface unit 140 may be configured to transfer instructions and data between system memory and L2 cache 130 and between system memory and L1 instruction cache 101A and L1 data cache 101B. In one embodiment, bus interface unit 140 may include buffers (not shown) for buffering write transactions during write cycle streamlining.

In one particular embodiment of the microprocessor 100 employing the x86 processor architecture, instruction cache 101A and data cache 101B may be physically addressed. As described above, the virtual addresses may optionally be translated to physical addresses for accessing system memory. The virtual-to-physical address translation is specified by the paging portion of the x86 address translation mechanism. The physical address may be compared to the physical tags to determine a hit/miss status. To reduce latencies associated with address translations, the address translations may be stored within a translation lookaside buffer (TLB) such as TLB 107A and TLB 107B.

In the illustrated embodiment, the TLB 107A is coupled to instruction cache 101A for storing the most recently used virtual-to-physical address translations associated with instruction cache 101A. Similarly, the TLB 107B is coupled to data cache 101B for storing the most recently used virtual-to-physical address translations associated with data cache 101B. It is noted that although the TLB 107A and 107B are shown as separate TLB structures, in other embodiments they may be implemented as a single TLB structure 107.

It should be noted that the components described with reference to FIG. 1 are meant to be exemplary only, and are not intended to limit the invention to any specific set of components or configurations. For example, in various embodiments, one or more of the components described may be omitted, combined, modified, or additional components included, as desired. For instance, in some embodiments, the microprocessor 100 may include two or more recycling AGUs. Also, in other embodiments the recycling AGU 150 may be located outside the execution unit.

Recycling AGU

Referring to FIG. 2, a block diagram of one embodiment of the recycling AGU 150 including a single adder is shown. Components that correspond to those shown in FIG. 2 are numbered identically for simplicity and clarity. The recycling AGU 150 may be comprised in an integrated circuit (IC), for example, a digital IC, which may be included in a microprocessor, e.g., the microprocessor 100 of FIG. 1. In one embodiment, the recycling AGU 150 may be comprised in an execution unit (e.g., execution unit 124) of a microprocessor. The recycling AGU 150 may perform address generation operations using a single adder by recycling sums of operands from the output of the adder to the input stage of the recycling AGU 150, as will be further described below.

The recycling AGU 150 of FIG. 2 includes a first multiplexer 210, a second multiplexer 220, a flip-flop 215, a flip-flop 225, an adder 230, and a flip-flop 235. In one embodiment, the multiplexers 210 may include a first and a second input terminal and an output terminal, and the multiplexer 220 may include a first, a second, a third, and a fourth input terminal and an output terminal. It is noted however that in other embodiments the multiplexers 210 and 220 may include any number of input terminals. It is also noted that in some embodiments the recycling AGU 150 may only include a single multiplexer or may include more than two multiplexers. In one embodiment, the adder 230 includes a first input terminal, a second input terminal, and an output terminal. The output terminal of the multiplexer 210 may be connected to the flip-flop 215 and the output terminal of the multiplexer 220 is connected to the flip-flop 225. Also, the output of the flip-flops 215 may be connected to the first input terminal of the adder 230 and the output of the flip-flop 225 may be connected to the second input terminal of the adder 230. The output terminal of the adder 230 is coupled to the flip-flop 235. In addition, the output of the flip-flop 235 may be connected to the recycle path 240 and to a cache, e.g., the cache 101B shown in FIG. 1. It is noted however that in other embodiments the flip-flop 235 may be connected to other devices, e.g., any other type of memory device.

The recycle path 240 may be coupled between the output of the flip-flop 235 and one of the input terminals (e.g., the first input terminal) of the multiplexer 210. Furthermore, the second input terminal of the multiplexer 210 may receive an index register operand, the first input terminal of the multiplexer 220 may receive a base register operand, the second input terminal of the multiplexer 220 may receive a displacement operand, the third input terminal of the multiplexer 220 may receive a segment base operand, and the fourth input terminal of the multiplexer 220 may receive a next line operand. The recycling AGU 150 may receive the operands from a scheduler, e.g., the scheduler 118 of shown in FIG. 1. It is noted however that in some embodiments the recycling AGU 150 may receive the operands from other devices or registers.

It should be noted that the components described with reference to FIG. 2 are meant to be exemplary only, and are not intended to limit the invention to any specific set of components or configurations. For example, in various embodiments, one or more of the components described may be omitted, combined, modified, or additional components included, as desired. For instance, in some embodiments the multiplexers 210 and 220 may be other types of selection devices, and the flip-flops 215, 225, and 235 may be other types of sequential logic devices (e.g., latches) or memory devices. Also, in some embodiments any one of the particular operands (e.g., the displacement operand) may be received in any one of the input terminals of the multiplexers 210 and 220.

Since the recycling AGU 150 includes only a single adder (e.g., adder 230), it reduces the hardware necessary to perform the multiple computations that are typically required in an address generation operation without adversely affecting performance. As described above, the recycling AGU 150 includes the recycle path 140 connected between the output and input stages of the adder 230. An extra cycle may be used to recycle the result of a computation back into the adder 230 so additional operands may be added, but performance is typically maintained (and sometimes improved) by allowing other address calculations to use the adder 230 during the extra cycle when the results are recycled. By allowing interleaving of address calculations overall throughput may not be affected. Additionally, the die area that is required for a typical AGU is greatly reduced when using the recycling AGU 150 since it eliminates the extra adder stages.

FIG. 3 is a flow diagram illustrating a method for performing address generation calculations using the recycling AGU 150, according to one embodiment. It should be noted that in various embodiments, some of the steps shown may be performed concurrently, in a different order than shown, or omitted. Additional steps may also be performed as desired.

Referring collectively to FIG. 2 and FIG. 3, the recycling AGU 150 may receive one or more operands for a first address generation operation, as indicated in block 305. The recycling AGU may receive one or more of the following operands for the first operation: an index register operand, a base register operand, a displacement operand, a segment base operand, and a next line operand. A portion of the operands may be received at the multiplexer 210 and a remaining portion of the operands may be received at the multiplexer 220. As described above, in one example, one of the operands may be received at the multiplexer 210 and four operands may be received at the multiplexer 220. The multiplexer 210 may also receive data on the recycle path; therefore, the multiplexer 210 may be configured to select either a first operand (e.g., the index register) or the data on the recycle path. Also, the multiplexer 220 may be configured to select one of the four operands. After receiving the operands during the first address generation operation, the multiplexer 210 may select a first operand and the multiplexer 220 may select a second operand. Next, the flip-flops 215 and 225 may latch and provide the selected operands to the adder 230. The first operand (e.g., the index register) may be received at the first input terminal of the adder 230 and the second operand (e.g., the base register) may be received at the second input terminal of the adder 230.

In an initial computation for the first address generation operation, the adder 230 may sum the first and second operand (block 310). The flip-flop 235 may latch and provide the sum of the first and second operand, or the first output sum, to the output of the recycling AGU 150 and to the recycle path 140. The first output sum may then be recycled back to one of the multiplexers 210 and 220 via the recycle path 240 (block 315). In the illustrated embodiment, first output sum is recycled back to the multiplexer 210. It is noted that the flip-flops of the recycling AGU 150 may manage the timing of the various computations and recycling functions of each of the address generation operations.

The recycling of the first output sum corresponding to the first address generation operation may take one cycle to perform. During this cycle, if a second address generation operation is pending, an initial computation of the second address generation operation may be performed. In this case, one or more operands corresponding to the second address generation operation may be received at the recycling AGU 150, and in the initial computation of the second address generation operation, the adder 230 may sum a first operand and a second operand to generate a first output sum for the second address generation operation while the first output sum corresponding to the first address generation operation is being recycled (block 320). Therefore, to make use of the adder 230 during the cycle when the recycling function is being performed, the second address generation may be interleaved with the first address generation operation. Similarly, other address generation operations may be interleaved with a current operation, e.g., a third address generation operation may be interleaved with the second address generation operation. It is noted that the flip-flops of the recycling AGU 150 may manage the timing of the various computations and recycling functions so that if address generation operations are interleaved the data from one operation does not collide with data from another operation.

After the first output sum is recycled, it may be determined whether the first address generation operation requires additional operands to be added to the first output sum to generate the appropriate address (block 325). If no additional operands are required, e.g., the first output sum is the appropriate address, the recycling AGU 150 may continue performing address generation operations (block 330), for example, the recycling AGU 150 may continue performing the second address generation operation and may interleave a third address generation operation. If at least one additional operand is needed, the recycling AGU 150 may perform a first recycle operation for the first address generation operation. In the first recycle computation, the multiplexer 210 may select the first output sum received via the recycle path 240 and the multiplexer 220 may select a third operand (e.g., the displacement). Then, the adder 230 may sum the first output sum and the third operand to generate a second output sum for the first operation (block 340).

While the adder 230 is performing the first recycle operation for the first address generation operation, the recycling AGU 150 may continue interleaving the second address generation operation with the first operation (block 345), i.e., the first output sum of the second address generation operation may recycled back to the multiplexer 210 via the recycle path 240. After the first recycle operation is performed, the second output sum of the first address generation operation may be recycled back to the multiplexer 210 (block 350). While the second output sum of the first operation is being recycled, if the second address generation operation requires additional operands, the adder 230 may sum the first output sum of the second operation and a third operand to generation a second output sum for the second operation.

After the second output sum for the first address generation operation is recycled, it may be determined whether the first operation requires additional operands to be added to the second output sum to generate the appropriate address (block 325). If at least one additional operand is needed, the recycling AGU 150 may perform a second recycle operation for the first address generation operation. In the second recycle operation, the multiplexer 210 may select the second output sum received via the recycle path 240 and the multiplexer 220 may select a fourth operand (e.g., the segment base), and then the adder 230 may sum the second output sum and the third operand to generate a third output sum for the first operation (block 340). Next, the third output sum may be recycled back to the multiplexer 210 (block 350).

After the third output sum is recycled, it may be determined if the first address generation operation requires a fifth operand (block 325). The fifth operand may be the next line operand, which may be used in memory accesses that require reading two lines from memory. In one embodiment, the next line operand may be needed to compute the address of a sequential cache line when an access the to an internal cache requires reading data from two cache lines. For example, in some embodiments, the internal cache may include 16 byte lines. In this example, a portion of the data needed for an operation may be stored in a first cache line and the remaining portion of the data may be stored in a second cache line. To perform an access to the cache, an initial address may be first calculated by the recycling AGU 150 (as described above) to access the first line of the cache. The initial address may then be output from the recycling AGU 150 and also recycled back to the input stage of the recycling AGU 150 via the recycle path 240. To access the remaining portion of the data that is stored in the second cache line, the next line operand is added in the next computation. If the cache lines are 16 bytes, the next line operand may also be called a +16 operand. More specifically, if the cache lines are N bytes, the next line operand may increment the initial address by N. In this example above, the next line operand (or +16 operand) may increment the initial address by 16 bytes to point to the beginning of the second cache line, i.e., in a binary sense, you add 10000 to the initial address. It is noted that in some embodiments width of the cache lines may be any number of bytes wide, for example, the cache lines may be 8, 16, or 32 bytes wide. It is also noted that in some embodiments the next line operand (or +N operand) may be used in any of the various computations (e.g., a second recycle computation) in a particular address generation operation.

If the fifth operand is required for the first address generation operation, the recycling AGU 150 may perform a third recycle computation. In the third recycle computation, the adder 230 may sum the third output sum and the fifth operand (e.g., the next line operand) to generate the fourth output sum (block 340) for the first operation. Next, the fourth output sum may be recycled back to the multiplexer 210 via the recycle path 240 (block 350).

It is noted that the number of operands that may be required to be summed in a particular address generation calculation varies from operation to operation. The initial computation (i.e., adding a first operand selected by the multiplexer 210 and a second operand selected by the multiplexer 220) may be performed if at least two operands are to be summed in a particular address generation calculation. Both the initial computation and the first recycle computation (i.e., adding a first output sum to a third operand) may be performed if at least three operands needed. The initial, first recycle, and second recycle computations are performed if at least four operands are needed, and the initial, first recycle, second recycle, and third recycle computations are performed if at least five operands are needed. It is also noted that in other embodiments additional computations involving additional operands (e.g., a sixth operand) may be performed for some address generation operations.

In some embodiments, the recycling AGU 150 may improve throughput. Traditional AGUs typically have sequential adders and then a multiplexer at the output stage that is shared to select the appropriate output. Therefore, in the traditional case, a short computation that requires only one or two adders may collide at the multiplexer with a computation that requires three or four adders. In other words, since the multiplexer may only be configured to select one of the adder outputs, one of the computations may be held back an extra cycle by the multiplexer. In the illustrated embodiment of FIG. 2, the recycling AGU 150 does not include a multiplexer at the output stage. Therefore, since it may be less likely that computations will collide, the recycling AGU 150 may improve throughput over traditional AGUs.

In some embodiments, the recycling AGU 150 may be used in any device that accesses a memory. Also, in other embodiments, the recycling AGU 150 may be used by software to add a series of numbers together. In general, the recycling AGU 150 may be used in applications requiring the addition of multiple data and the performance of the necessary computations in a very short cycle time.

Computer System

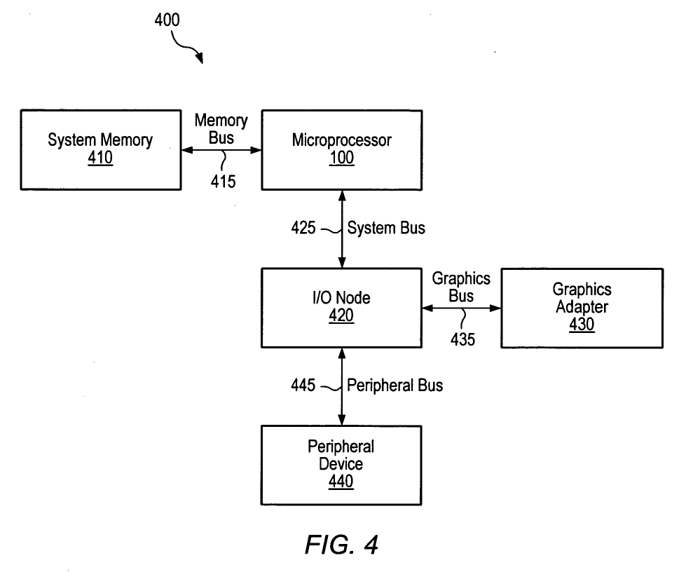

Turning to FIG. 4, a block diagram of one embodiment of a computer system 400 is shown. Components that correspond to those shown in FIG. 1 and FIG. 2 are numbered identically for clarity and simplicity. Computer system 400 includes the microprocessor 100 of FIG. 1, which is coupled to a system memory 410 via a memory bus 415. Microprocessor 100 is further coupled to an I/O node 420 via a system bus 425. I/O node 420 is coupled to a graphics adapter 430 via a graphics bus 435. I/O node 420 is also coupled to a peripheral device 440 via a peripheral bus 445.

In the illustrated embodiment, microprocessor 100 is coupled directly to system memory 410 via memory bus 415. For controlling accesses to system memory 410, microprocessor may include a memory controller (not shown) within bus interface unit 140 of FIG. 1, for example. It is noted however that in other embodiments, system memory 410 may be coupled to microprocessor 100 through I/O node 420. In such an embodiment, I/O node 420 may include a memory controller (not shown). Further, in one embodiment, microprocessor 100 includes one or more recycling AGUs 150 of FIG. 2, for example.

System memory 410 may include any suitable memory devices. For example, in one embodiment, system memory may include one or more banks of memory devices in the dynamic random access memory (DRAM) family of devices. Although it is contemplated that other embodiments may include other memory devices and configurations.

In the illustrated embodiment, I/O node 420 is coupled to a graphics bus 435, a peripheral bus 440 and a system bus 425. Accordingly, I/O node 420 may include a variety of bus interface logic (not shown) which may include buffers and control logic for managing the flow of transactions between the various buses. In one embodiment, system bus 425 may be a packet based interconnect compatible with the HyperTransport™ technology. In such an embodiment, I/O node 420 may be configured to handle packet transactions. In alternative embodiments, system bus 425 may be a typical shared bus architecture such as a front-side bus (FSB), for example.

Further, graphics bus 435 may be compatible with accelerated graphics port (AGP) bus technology. In one embodiment, graphics adapter 430 may be any of a variety of graphics devices configured to generate graphics images for display. Peripheral bus 445 may be an example of a common peripheral bus such as a peripheral component interconnect (PCI) bus, for example. Peripheral device 440 may any type of peripheral device such as a modem or sound card, for example.

It should be noted that the components described with reference to FIG. 4 are meant to be exemplary only, and are not intended to limit the invention to any specific set of components or configurations. For example, in various embodiments, one or more of the components described may be omitted, combined, modified, or additional components included, as desired. For instance, in some embodiments the recycling AGU (e.g., AGU 150 of FIG. 2) may be included in other types of devices of the computer system, e.g., a digital signal processor (not shown).

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. An address generation unit (AGU) comprising:
an adder including a first input terminal, a second input terminal, and an output terminal;
one or more selection devices coupled to the first and second input terminals of the adder;
a recycle path coupled to connect the output terminal of the adder to one of the one or more selection devices;
wherein the AGU is configured to receive a plurality of operands at the one or more selection devices, wherein the adder is configured to sum a portion of the plurality of the operands received at the first and second input terminals of the adder to generate an output sum, and wherein the output sum of the adder is recycled back to the one selection device via the recycle path to perform an address generation operation using a single adder.

2. The AGU of claim 1, wherein a sum that is output from the adder is recycled back to the one selection device one or more times via the recycle path depending on whether the address generation operation requires one or more additional operands to be added to generate a corresponding address.

3. The AGU of claim 1, wherein the AGU includes a first selection device coupled to the first input terminal of the adder, wherein the recycle path is coupled to the first selection device, wherein the first selection device is configured to receive a first operand and a recycled output sum, wherein the first selection device is configured to select either the first operand or the recycled output sum to be provided to the adder.

4. The AGU of claim 3, wherein the AGU also includes a second selection device coupled to the second input terminal of the adder, wherein the second selection device is configured to receive a second operand, a third operand, a fourth operand, and a fifth operand, wherein the second selection device is configured to select either the second operand, third operand, fourth operand, or fifth operand to be provided to the adder.

5. The AGU of claim 4, wherein, in an initial computation of a first address generation operation, the adder sums the first operand and one of the second, third, fourth, and fifth operands to generate a first output sum, wherein the first output sum is recycled back to the first selection device via the recycle path.

6. The AGU of claim 5, wherein, in a first recycle computation of the first address generation operation, the adder sums the first output sum and one of the second, third, fourth, and fifth operands that was not selected in the initial computation to generate a second output sum, wherein the second output sum is recycled back to the first selection device via the recycle path.

7. The AGU of claim 6, wherein, in a second recycle computation of the first address generation operation, the adder sums the second output sum and one of the second, third, fourth, and fifth operands that was not selected in the initial or first recycle computations to generate a third output sum, wherein the third output sum is recycled back to the first selection device via the recycle path.

8. The AGU of claim 7, wherein, in a third recycle computation of the first address generation operation, the adder sums the third output sum and one of the second, third, fourth, and fifth operands that was not selected in the initial, first recycle, or second recycle computations to generate a fourth output sum, wherein the fourth output sum is recycled back to the first selection device via the recycle path.

9. The AGU of claim 8, wherein a number of operands to be summed in a particular address generation calculation varies from operation to operation, wherein the initial computation is performed if at least two operands are to be summed in a particular address generation calculation, wherein the initial and first recycle computations are performed if at least three operands are to be summed in a particular address generation calculation, wherein the initial, first recycle, and second recycle computations are performed if at least four operands are to be summed in a particular address generation calculation, and wherein the initial, first recycle, second recycle, and third recycle computations are performed if at least five operands are to be summed in a particular address generation calculation.

10. The AGU of claim 6, wherein, while the first output sum corresponding to the first address generation operation is being recycled back to the first selection device, an initial computation of a second address generation operation is performed, wherein in the initial computation of the second address generation operation the adder sums a first operand and one of the second, third, fourth, and fifth operands corresponding to the second address generation operation to generate a first output sum of the second address generation operation, wherein the first output sum of the second address generation operation is recycled back to the first selection device via the recycle path while the first recycle computation of the first address generation operation is being performed.

11. The AGU of claim 10, configured to continue to interleave the second address generation operation with the first address generation operation to use the adder to perform computations during a cycle when an output sum is recycled for the first address generation operation.

12. The AGU of claim 4, further comprising a first flip-flop coupled between an output terminal of the first selection device and the first input terminal of the adder, a second flip-flop coupled between an output terminal of the second selection device and the second input terminal of the adder, and a third flip-flop coupled between the output terminal of the adder and the recycle path.

13. A method for performing address generation operations in a microprocessor including an address generation unit (AGU), wherein the AGU includes an adder and one or more selection devices, wherein the method comprises:
receiving a plurality of operands at the one or more selection devices of the AGU;
summing a portion of the plurality of the operands received at the AGU to generate an output sum; and
recycling the output sum of the adder back to one of the one or more selection devices via a recycle path to perform an address generation operation using a single adder.

14. The method of claim 13, further comprising recycling a sum that is output from the adder back to the one selection device one or more times via the recycle path depending on whether the address generation operation requires one or more additional operands to be added to generate a corresponding address.

15. The method of claim 13, wherein said receiving a plurality of operands at the one or more selection devices of the AGU includes receiving a first operand and a recycled output sum at a first selection device and receiving a second operand, a third operand, a fourth operand, and a fifth operand at a second selection device.

16. The method of claim 15, wherein said summing a portion of the plurality of the operands and said recycling the output sum is performed in a first address generation operation, wherein said summing a portion of the plurality of the operands includes the adder summing the first operand and one of the second, third, fourth, and fifth operands to generate a first output sum, wherein said recycling the output sum includes recycling the first output sum back to the first selection device via the recycle path.

17. The method of claim 16, further comprising performing a first recycle computation of the first address generation operation, wherein said performing a first recycle computation includes the adder summing the first output sum and one of the second, third, fourth, and fifth operands that was not selected in the initial computation to generate a second output sum, wherein said performing a first recycle computation also includes recycling the second output sum back to the first selection device via the recycle path.

18. The method of claim 17, wherein a number of operands to be summed in a particular address generation calculation varies from operation to operation, wherein the initial computation is performed if at least two operands are to be summed in a particular address generation calculation, wherein the initial and first recycle computations are performed if at least three operands are to be summed in a particular address generation calculation.

19. The method of claim 17, further comprising, while the first output sum corresponding to the first address generation operation is being recycled back to the first selection device, performing an initial computation of a second address generation operation, wherein said performing an initial computation of a second address generation operation includes the adder summing a first operand and one of the second, third, fourth, and fifth operands corresponding to the second address generation operation to generate a first output sum of the second address generation operation, wherein said performing an initial computation of a second address generation operation also includes recycling the first output sum of the second address generation operation back to the first selection device via the recycle path while the first recycle computation of the first address generation operation is being performed.

20. The method of claim 17, further comprising continuing to interleave the second address generation operation with the first address generation operation to use the adder to perform computations during a cycle when an output sum is recycled for the first address generation operation.

21. A microprocessor comprising:
one or more caches; and
an address generation unit (AGU) coupled to at least one of the caches, the AGU comprising:
an adder including a first input terminal, a second input terminal, and an output terminal;
one or more selection devices coupled to the first and second input terminals of the adder;
a recycle path coupled to connect the output terminal of the adder to one of the one or more selection devices;
wherein the AGU is configured to receive a plurality of operands at the one or more selection devices, wherein the adder is configured to sum a portion of the plurality of the operands received at the first and second input terminals of the adder to generate an output sum, and wherein the output sum of the adder is recycled back to the one selection device via the recycle path to perform an address generation operation using a single adder.

22. The microprocessor of claim 21, wherein a sum that is output from the adder is recycled back to the one selection device one or more times via the recycle path depending on whether the address generation operation requires one or more additional operands to be added to generate a corresponding address.

23. The microprocessor of claim 21, wherein the AGU includes a first selection device coupled to the first input terminal of the adder, wherein the recycle path is coupled to the first selection device, wherein the first selection device is configured to receive a first operand and a recycled output sum, wherein the first selection device is configured to select either the first operand or the recycled output sum to be provided to the adder, and wherein the AGU also includes a second selection device coupled to the second input terminal of the adder, wherein the second selection device is configured to receive a second operand, a third operand, a fourth operand, and a fifth operand, wherein the second selection device is configured to select either the second operand, third operand, fourth operand, or fifth operand to be provided to the adder.

24. The microprocessor of claim 23, wherein, in an initial computation of a first address generation operation, the adder sums the first operand and one of the second, third, fourth, and fifth operands to generate a first output sum, wherein the first output sum is recycled back to the first selection device via the recycle path, and wherein, in a first recycle computation of the first address generation operation, the adder sums the first output sum and one of the second, third, fourth, and fifth operands that was not selected in the initial computation to generate a second output sum, wherein the second output sum is recycled back to the first selection device via the recycle path.

25. The microprocessor of claim 24, wherein, while the first output sum corresponding to the first address generation operation is being recycled back to the first selection device, an initial computation of a second address generation operation is performed, wherein in the initial computation of the second address generation operation the adder sums a first operand and one of the second, third, fourth, and fifth operands corresponding to the second address generation operation to generate a first output sum of the second address generation operation, wherein the first output sum of the second address generation operation is recycled back to the first selection device via the recycle path while the first recycle computation of the first address generation operation is being performed.

26. A computer system comprising:
a system memory; and
a microprocessor coupled to the system memory, the microprocessor including:
an address generation unit (AGU), which includes:
an adder including a first input terminal, a second input terminal, and an output terminal;
one or more selection devices coupled to the first and second input terminals of the adder;
a recycle path coupled to connect the output terminal of the adder to one of the one or more selection devices;
wherein the AGU is configured to receive a plurality of operands at the one or more selection devices, wherein the adder is configured to sum a portion of the plurality of the operands received at the first and second input terminals of the adder to generate an output sum, and wherein the output sum of the adder is recycled back to the one selection device via the recycle path to perform an address generation operation using a single adder.
